(19) United States
(12) Patent Application Publication
(10) Pub. No.: US 2026/0120947 A1
(43) Pub. Date: Apr. 30, 2026

(54) MULTILAYER CERAMIC ELECTRONIC COMPONENT

(71) Applicant: TAIYO YUDEN CO., LTD., Tokyo (JP)

(72) Inventors: Remi IIZUKA, Tokyo (JP); Minoru RYU, Tokyo (JP); Yoshiki IWAZAKI, Tokyo (JP)

(21) Appl. No.: 19/359,054

(22) Filed: Oct. 15, 2025

(30) Foreign Application Priority Data
Oct. 29, 2024 (JP) 2024-190170

(51) Int. Cl. H01G 4/008; H01G 4/12; H01G 4/232; H01G 4/248; H01G 4/30

(52) U.S. Cl. CPC H01G 4/008; H01G 4/1209; H01G 4/232; H01G 4/248; H01G 4/30

(57) ABSTRACT

To provide a multilayer ceramic electronic component having excellent lifetime characteristics. A multilayer ceramic electronic component includes: a plurality of dielectric layers laminated along a first axis; a plurality of internal electrode layers located between the dielectric layers that are adjacent along the first axis; and intermediate regions located between the dielectric layers and the internal electrode layers. The dielectric layers contain a compound represented by a general formula of ABO_{3-α} (0≤α≤1) and having a perovskite structure. The internal electrode layers contain a base metal element as a main component. The intermediate regions contain copper and copper oxide.

### CROSS-REFERENCE TO RELATED APPLICATION

The present application claims priority under 35 U.S.C. § 119 to Japanese Patent Application No. 2024-190170, filed Oct. 29, 2024, the contents of which are incorporated herein by reference in their entireties.

### BACKGROUND OF THE INVENTION

### Field of the Invention

The present disclosure relates to a multilayer ceramic electronic component.

### Description of the Related Art

Multilayer ceramic electronic components have a structure in which dielectric layers and internal electrode layers are laminated alternately. Examples of multilayer ceramic electronic components include Multilayer Ceramic Capacitors (MLCCs).

Multilayer ceramic capacitors, which are a type of multilayer ceramic electronic components, can store electricity and flow high-frequency waves. Therefore, multilayer ceramic capacitors are installed in various electronic devices for the purpose of voltage stabilization, noise elimination, and the like. Multilayer ceramic electronic components are especially used in communication devices, such as smartphones and the like.

Since multilayer ceramic electronic components are rarely replaced after being installed in electronic devices, they are required to have excellent lifetime characteristics. Therefore, multilayer ceramic electronic components with improved lifetime characteristics have been studied.

For example, Japanese Patent Application Laid-Open Publication No. 2023-158176 discloses a ceramic electronic component including a multilayer chip in which a plurality of dielectric layers composed mainly of a ceramic material and a plurality of internal electrode layers are laminated, wherein the internal electrode layers contain Ni, Sn, and Au, and concentration gradients are formed such that the concentration of Au and the concentration of Sn gradually decrease from the interface between the dielectric layers and the internal electrode layers toward the interior in the thickness direction of the dielectric layers.

### SUMMARY OF THE INVENTION

However, the ceramic electronic component disclosed in Japanese Patent Application Laid-Open Publication No. 2023-158176 requires relatively expensive materials, such as gold and the like. Therefore, there has been a need for a novel multilayer ceramic electronic component having excellent lifetime characteristics and being different from existing multilayer ceramic electronic components in the configuration of materials and the like.

It is an object of the present disclosure to provide a multilayer ceramic electronic component having excellent lifetime characteristics.

A multilayer ceramic electronic component of the present disclosure includes:
a plurality of dielectric layers laminated along a first axis;
a plurality of internal electrode layers each of which is located between the dielectric layers that are adjacent along the first axis; and
intermediate regions located between the dielectric layers and the internal electrode layers,
wherein the dielectric layers contain a compound represented by a general formula of ABO_{3-α} (0≤α≤1) and having a perovskite structure,
the internal electrode layers contain a base metal element as a main component, and
the intermediate regions contain copper and copper oxide.

According to the present disclosure, it is possible to provide a multilayer ceramic electronic component having excellent lifetime characteristics.

### BRIEF DESCRIPTION OF THE DRAWINGS

FIG. 1 is an oblique view showing partial cross-sections of a multilayer ceramic capacitor according to an embodiment of the present disclosure;

FIG. 2 is a cross-sectional view showing a multilayer ceramic capacitor according to an embodiment of the present disclosure;

FIG. 3 is a cross-sectional view showing a multilayer ceramic capacitor according to an embodiment of the present disclosure;

FIG. 4 is a cross-sectional view showing details of an element body according to an embodiment of the present disclosure;

FIG. 5A is an enlarged schematic view of a region D of FIG. 4;

FIG. 5B is an enlarged schematic view of a region D of FIG. 4;

FIG. 5C is an enlarged schematic view of a region D of FIG. 4;

FIG. 6 is a flowchart of a method for manufacturing a multilayer ceramic capacitor according to an embodiment of the present disclosure;

FIG. 7A is a view showing a method for manufacturing a multilayer ceramic capacitor according to an embodiment of the present disclosure; and

FIG. 7B is a view showing a method for manufacturing a multilayer ceramic capacitor according to an embodiment of the present disclosure.

### DETAILED DESCRIPTION OF THE DISCLOSURE

Embodiments of the present disclosure will be described in detail below, but the present disclosure is not limited thereto. In the present specification and drawings, components having substantially the same functional configuration may be denoted by the same reference numerals to omit duplicate descriptions. Also, in the drawings, mutually orthogonal X, Y, and Z axes are shown as appropriate. The X, Y, and Z axes define a fixed coordinate system fixed to a multilayer ceramic capacitor, which is an example of a multilayer ceramic electronic component. The X, Y, and Z axes may correspond to the length, width, and height of a multilayer ceramic capacitor, which is an example of a multilayer ceramic electronic component, when the multilayer ceramic capacitor has an approximately rectangular parallelepiped outer shape. The multilayer ceramic electronic component of the present embodiment will be described below using a multilayer ceramic capacitor, which is an example of the multilayer ceramic electronic component.

### [Multilayer Ceramic Electronic Component]

### (1) Structure of Multilayer Ceramic Electronic Component

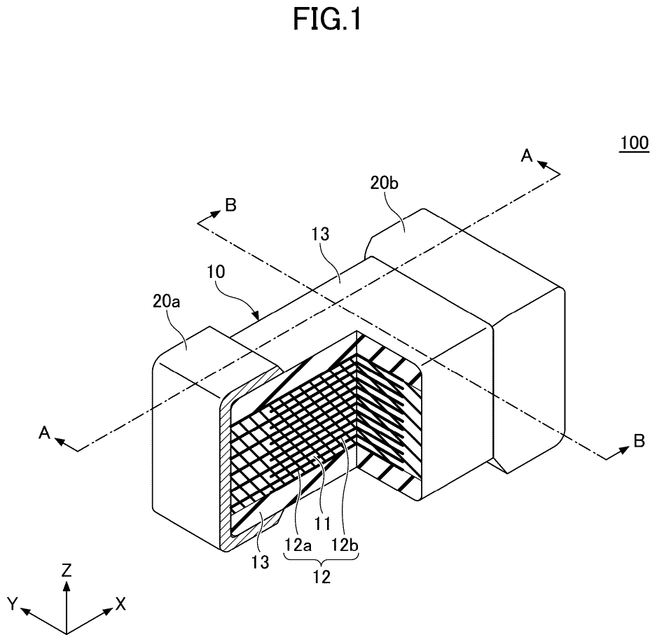

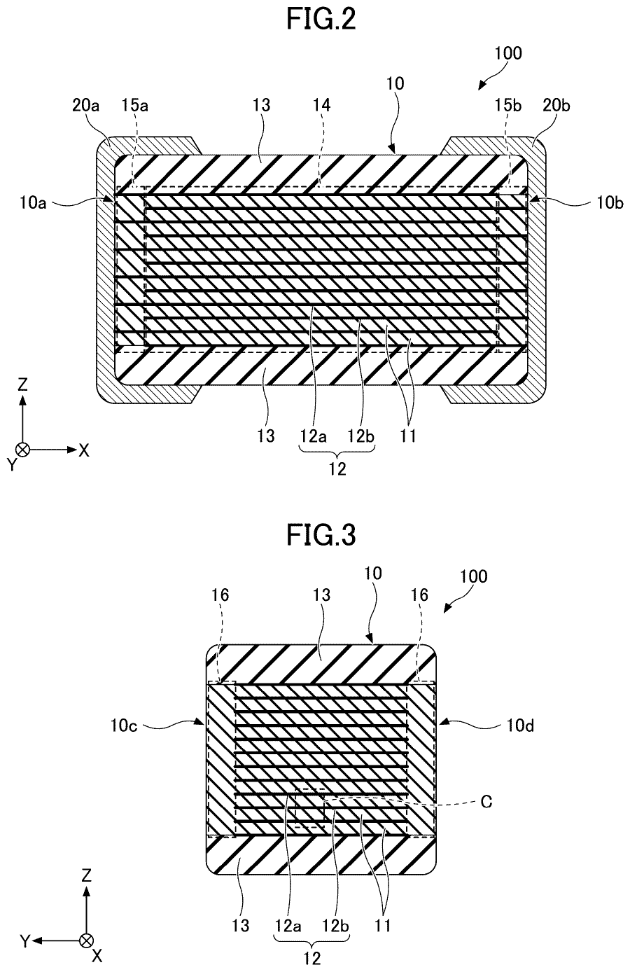

FIG. 1 is an oblique view showing partial cross-sections of a multilayer ceramic capacitor 100. FIGS. 2 and 3 are cross-sectional views showing the multilayer ceramic capacitor. FIG. 2 is a cross-sectional view taken along a line A-A in FIG. 1. FIG. 3 is a cross-sectional view taken along a line B-B in FIG. 1. As shown in FIGS. 1 to 3, the multilayer ceramic capacitor 100 includes an element body 10 having a substantially rectangular parallelepiped shape. Two surfaces included in the outer surfaces of the element body 10 and facing each other are referred to as an upper surface and a lower surface, and four surfaces connecting the upper surface and the lower surface are referred to as side surfaces, respectively. Typically, but non-limitatively, a surface of the multilayer ceramic capacitor that is on the circuit board side when mounting the multilayer ceramic capacitor on the circuit board is referred to as the lower surface, In the example shown in FIGS. 1 to 3, the element body 10 is provided with a first external electrode 20a and a second external electrode 20b on a first side surface 10a and a second side surface 10b (see FIG. 2), which are two facing side surfaces. The first external electrode 20a extends from the first side surface 10a to four adjacent surfaces. The second external electrode 20b extends from the second side surface 10b to four adjacent surfaces. However, the first external electrode 20a and the second external electrode 20b are spaced apart from each other. The external electrodes may be provided not only on the two facing side surfaces but also anywhere on the outer surfaces of the element body 10.

The lamination direction in which dielectric layers 11 and internal electrode layers 12 are laminated is along a first axis. In FIGS. 1 to 3, the first axis that is along the lamination direction in which the dielectric layers 11 and the internal electrode layers 12 are laminated is the Z axis, which is along the direction in which the internal electrode layers face each other.

An axis perpendicular to the first axis, which is along the lamination direction, is a second axis. In FIGS. 1 to 3, the second axis, which is the axis perpendicular to the first axis, which is along the lamination direction, is the X axis. The second axis is along the length direction of the element body 10, and is along the direction in which the first side surface 10a and the second side surface 10b of the element body 10 face each other, and the direction in which the first external electrode 20a and the second external electrode 20b face each other.

An axis perpendicular to the first axis, which is along the lamination direction, and perpendicular to the second axis is a third axis. The third axis is along the width of the internal electrode layers 12. In FIGS. 1 to 3, the third axis perpendicular to the first axis, which is along the lamination direction, and perpendicular to the second axis, is the Y axis. The third axis is an axis along the direction in which a third side surface 10c and a fourth side surface 10d, which are two side surfaces other than the first side surface 10a and the second side surface 10b among the four side surfaces of the element body 10, face each other (see FIG. 3). The X axis, the Y axis, and the Z axis are orthogonal to each other.

The lamination direction is not limited to the Z direction, and can be any direction. Therefore, for example, the first axis, which is along the lamination direction, may be the X axis in the X direction or the Y axis in the Y direction.

In this specification, a view showing one specific embodiment may be used to describe a general embodiment. However, the contents described based on the coordinate system used in one embodiment are applicable to general embodiments by reading the coordinate system in the one embodiment as a general coordinate system in which the lamination direction is along the first axis. For example, those that are used in FIGS. 1 to 3 relating to one specific embodiment, in which the lamination direction coincides with the Z direction, and that are referred to as the X axis, the Y axis, and the Z axis are applicable to general embodiments by being read as the second axis, the third axis, and the first axis in the general embodiment.

The element body 10 has a configuration in which the dielectric layers 11 containing a ceramic material functioning as a dielectric material and the internal electrode layers 12 are laminated alternately. The internal electrode layers 12 include a plurality of first internal electrode layers 12a and a plurality of second internal electrode layers 12b. The first internal electrode layers 12a and the second internal electrode layers 12b are laminated alternately. The edges of the first internal electrode layers 12a are extracted to the surface of the element body 10 on which the first external electrode 20a is provided, which is the first side surface 10a in the example of FIGS. 1 to 3. The edges of the second internal electrode layers 12b are extracted to the surface of the element body 10 on which the second external electrode 20b is provided, which is the second side surface 10b in the example of FIGS. 1 to 3. Thus, the first internal electrode layers 12a and the second internal electrode layers 12b are in electrical conduction with the first external electrode 20a and the second external electrode 20b alternately. Therefore, the multilayer ceramic capacitor 100 has a configuration in which capacitor units are laminated. In the laminate of the dielectric layers 11 and the internal electrode layers 12, internal electrode layers 12 are positioned on the outermost layers in the lamination direction, and the outer surfaces of the laminate in the lamination direction, which are the upper surface and the lower surface in the example of FIGS. 1 to 3, are covered with a cover layer 13. The cover layer 13 is mainly composed of a ceramic material. For example, the cover layer 13 may have a composition that is the same as or different from that of the dielectric layers 11. The configuration shown in FIGS. 1 to 3 is non-limiting, as long as the first internal electrode layers 12a and the second internal electrode layers 12b are exposed to different regions among the surfaces of the laminate and are in electrical conduction with different external electrodes. The different regions among the surfaces of the laminate may be surface regions included in facing surfaces of the laminate, respectively, may be surface regions included in adjacent surfaces of the laminate, respectively, or may be different surface regions included in the same surface of the laminate. As long as the different external electrodes are spaced from each other, the external electrodes may extend from the surfaces of the laminate, which include the surface regions to which the first internal electrode layers 12a and the second internal electrode layers 12b are exposed, to any other surfaces.

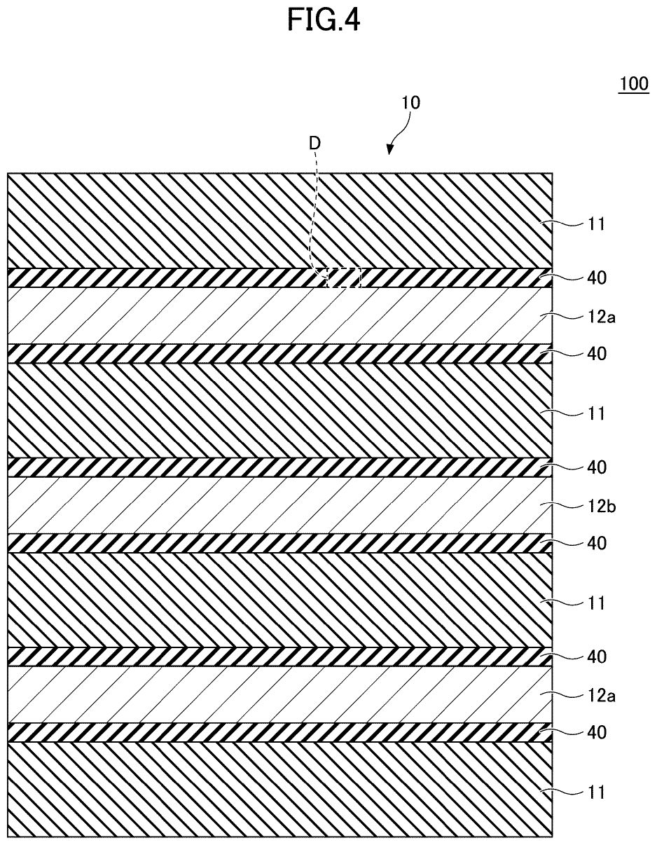

Although details will be described later, the element body 10 includes a plurality of intermediate regions 40 (see FIG. 4) between the dielectric layers 11 and the internal electrode layers 12. In FIGS. 1 to 3, description of the intermediate regions 40 is omitted.

The size of the multilayer ceramic capacitor 100 is not particularly limited. For example, the length may be 0.25 mm, the width may be 0.125 mm, and the height may be 0.125 mm. The length may be 0.4 mm, the width may be 0.2 mm, and the height may be 0.2 mm. The length may be 0.6 mm, the width may be 0.3 mm, and the height may be 0.3 mm. The length may be 1.0 mm, the width may be 0.5 mm, and the height may be 0.5 mm. The length may be 3.2 mm, the width may be 1.6 mm, and the height may be 1.6 mm. The length may be 4.5 mm, the width may be 3.2 mm, and the height may be 2.5 mm. The above listed sizes of the multilayer ceramic capacitor 100 are only examples, and the multilayer ceramic capacitor is not limited to the above sizes. The sizes of the multilayer ceramic capacitor 100 may be in the relationship of, for example, length>width≥height, width>length≥height, height>length≥width, or height>width≥length. For example, the length represents the size in the X-axis direction, the width represents the size in the Y-axis direction, and the height represents the size in the Z-axis direction.

As described above, the multilayer ceramic capacitor 100 of the present embodiment includes the plurality of dielectric layers 11 laminated along the Z-axis, which is the first axis, and the plurality of internal electrode layers 12, each of which is arranged between dielectric layers 11 adjacent along the first axis. Furthermore, the multilayer ceramic capacitor 100 of the present embodiment includes the intermediate regions 40 arranged between the dielectric layers 11 and the internal electrode layers 12. The dielectric layers 11, the internal electrode layers 12, and the intermediate regions 40 will be described below.

### (2) Dielectric Layer

The dielectric layer 11 contains a compound represented by a general formula: ABO_{3-α} (0≤α≤1) and having a perovskite structure.

### (2-1) Components Contained in Dielectric Layer

When having a stoichiometric composition, a compound having a perovskite structure is represented by a general formula: ABO₃, with α, which represents the amount of deviation from the stoichiometric composition, being 0. The compound having a perovskite structure represented by the above general formula may have α that is greater than 0 and is equal to or less than 1. That is, the compound having the perovskite structure represented by the above general formula may be more oxygen-deficient than the stoichiometric composition.

As the compound having the perovskite structure, one or more types selected from barium titanate (BaTiO₃), calcium zirconate (CaZrO₃), calcium titanate (CaTiO₃), strontium titanate (SrTiO₃), magnesium titanate (MgTiO₃), Ba_{1-x-y}CaₓSr_{y}Ti_{1-z}Zr_{z}O₃ (0≤x≤1, 0≤y≤1, 0≤z≤1) forming a perovskite structure, and the like can be used.

Examples of Ba_{1-x-y}CaₓSr_{y}Ti_{1-z}Zr_{z}O₃ include barium strontium titanate, barium calcium titanate, barium zirconate, barium zirconate titanate, calcium zirconate titanate, barium calcium zirconate titanate, and the like. The compound having the perovskite structure may contain oxygen deficiency regardless of the type of the material.

It is preferable that the dielectric layer 11 contains barium titanate having particularly excellent dielectric characteristics as the compound having the perovskite structure, and may contain barium titanate as a main component, or may be composed only of barium titanate. Barium titanate has excellent dielectric characteristics, such as an extremely high dielectric constant, a low dielectric loss, and the like. Therefore, when the dielectric layer 11 contains barium titanate as the compound having the perovskite structure, the capacitance of the multilayer ceramic capacitor 100 can be increased. As used herein, “being contained as a main component” means that the component is contained in the highest amount in terms of the ratio by number of moles, among the components contained.

The dielectric layer 11 may contain the compound having the perovskite structure as a main component. For example, the dielectric layer 11 may contain the compound having the perovskite structure by 50 mol % or greater, or 90 mol % or greater.

### (Additive)

The dielectric layer 11 may contain an additive as an optional component.

An additive that can be contained in the dielectric layer 11 is not particularly limited. Examples of the additive include: oxides containing one or more elements selected from zirconium (Zr), magnesium (Mg), molybdenum (Mo), vanadium (V), chromium (Cr), and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm) and ytterbium (Yb)); oxides containing one or more elements selected from cobalt (Co), nickel (Ni), lithium (Li), boron (B), sodium (Na), potassium (K), and silicon (Si); glass containing one or more elements selected from cobalt, nickel, lithium, boron, sodium, potassium, and silicon; and the like.

### (2-2) Thickness of Dielectric Layer

The thickness of the dielectric layer 11 is not particularly limited, yet is, for example, preferably 1.0 μm or less, and more preferably 0.8 μm or less, in order to be able to increase the capacitance by increasing the number of layers to be laminated while reducing the size the multilayer ceramic capacitor 100.

The lower limit of the thickness of the dielectric layer 11 is not particularly limited, yet, from the viewpoint of improving productivity and yield, may be two to four times the average diameter of the dielectric material particles used. For example, when the average diameter of the dielectric material particles used is 0.1 μm, the lower limit of the thickness of the dielectric layer 11 may be 0.2 μm or greater and 0.4 μm or less. The thickness of the dielectric layer 11 may be, for example, 0.2 μm or greater or may be 0.4 μm, or greater.

The particle diameter of the dielectric material particles can be the Heywood diameter (which is the diameter of a circle having an area equal to the area of the dielectric material particles evaluated) in a cross-section observed. The average diameter, which is the average value of the particle diameters of the dielectric material particles, can be an arithmetic mean value of the particle diameters of 50 or more and 200 or less arbitrarily selected dielectric material particles.

In the evaluation of the thickness of the dielectric layer 11, a cross-section including the first axis equal to the lamination direction is evaluated. For example, it is preferable to perform evaluation using a cross-section further including the second axis set perpendicularly to the lamination direction, or a cross-section further including the third axis set perpendicularly to the lamination direction and also perpendicularly to the second axis, for ease with polishing and measurement. The multilayer ceramic capacitor 100 is polished in the third axis direction in the former case, and in the second axis direction in the latter case. Five layers are selected from each of the center part, the upper end part, and the lower end part of the exposed dielectric layers 11 in the first axis direction. When the number of dielectric layers 11 is even, six layers are selected from the center part. Then, the thickness is measured at a total of three positions of each of the selected dielectric layers, namely the center part, a left end part, and a right end part, and the average value of the measured thicknesses is used as the thickness of each dielectric layer 11. Furthermore, the average value of the thicknesses of all the selected and evaluated dielectric layers 11 can be used as the thickness of the dielectric layers 11 in the multilayer ceramic capacitor 100.

The example shown in FIGS. 1 and 2, in which the first axis, which is along the lamination direction, is in the Z-axis direction, is an example in which the multilayer ceramic capacitor 100 is polished along the Y-axis, which is the third axis, to expose an XZ surface in which the dielectric layers 11 and the internal electrode layers 12 are laminated.

In this case, from the exposed XZ surface, five dielectric layers 11 located at the center along the Z-axis, which is the first axis, and five dielectric layers 11 located at each of the upper end and the lower end along the Z-axis, which is the first axis, are selected. When the number of dielectric layers 11 is even, six layers may be selected from the center part. In this case, the dielectric layers 11 to be selected are selected from within a capacitive part 14.

Then, the thickness of each selected dielectric layer 11 is measured along the X axis, which is the second axis, at three positions spaced apart from an end by ¼, ½, and ¾ the length of the dielectric layer 11 along the X axis, is averaged as the thickness of the dielectric layer 11. By the same procedure, the thicknesses of all the selected dielectric layers 11 are measured, and can be averaged as the thickness of the dielectric layers 11 in the evaluated multilayer ceramic capacitor 100.

The thickness of the dielectric layers 11 and the thickness of the internal electrode layers 12, which will be described later, are measured from an image or the like of an observed cross-section of the multilayer ceramic capacitor 100. Since the intermediate regions 40 are not clearly visible in appearance, the thickness of the dielectric layers 11 and the thickness of the internal electrode layers 12 are measured based on the boundaries between the dielectric layers 11 and the internal electrode layers 12 that can be visually observed. Therefore, the intermediate region 40 is included in the thickness of the dielectric layer 11 and in the thickness of the internal electrode layer 12, which will be described later.

### (3) Internal Electrode Layer

### (3-1) Components Included in Internal Electrode Layer

As shown in FIG. 2, the region where the first internal electrode layers 12a connected to the first external electrode 20a and the second internal electrode layers 12b connected to the second external electrode 20b face each other is the region where the electric capacitance is generated in the multilayer ceramic capacitor 100. Therefore, the region where the electric capacitance is generated is referred to as the capacitive part 14. That is, the capacitive part 14 is a region where internal electrode layers connected to different external electrodes and adjacent to each other across the dielectric layers 11 face each other.

The region where the first internal electrode layers 12a connected to the first external electrode 20a face each other in the lamination direction via no second internal electrode layers 12b connected to the second external electrode 20b is referred to as a first end margin 15a. The region where the second internal electrode layers 12b connected to the second external electrode 20b face each other in the lamination direction via no first internal electrode layers 12a connected to the first external electrode 20a is referred to as a second end margin 15b. Each end margin is a region where the internal electrode layers connected to the same external electrode face each other in the lamination direction via no internal electrode layers connected to the different external electrode. The first end margin 15a and the second end margin 15b are regions where the internal electrode layers 12 having the same potential face each other and no substantial electric capacitance is generated.

Side margins 16 are regions provided on the outer sides of the capacitive part 14 along the third axis, which is perpendicular to the lamination direction and is perpendicular to the second axis, which is in the direction along the Y axis in the example of FIG. 3. That is, the side margins 16 are outer regions adjacent to the capacitive part 14 when viewed in the lamination direction, and are outer regions adjacent to the capacitive part 14 on the sides to which the internal electrode layers 12 are not extracted. The side margins 16 are also regions in which no electric capacitance is generated.

### (Base Metal)

The internal electrode layers 12 can contain a base metal element as a main component.

The internal electrode layers 12 can contain a component used in internal electrode layers of multilayer ceramic capacitors. The internal electrode layer 12 may contain a base metal, such as nickel (Ni), tin (Sn), tungsten (W), and the like, or an alloy containing one or more types selected from the group of these base metals, as a main component, i.e., in the highest amount in terms of the ratio by number of moles.

The internal electrode layer 12 may contain nickel, which has excellent electrical characteristics and is cost-saving, as a base metal element, and may contain nickel as a main component.

The main component of the first internal electrode layer 12a and the main component of the second internal electrode layer 12b may be the same or different. As an example, the main component of the first internal electrode layer 12a and the second internal electrode layer 12b may be the same and may both be nickel.

### (Copper and Copper Oxide)

According to the inventor of the present invention, when the intermediate regions described later contain copper and copper oxide, the lifetime characteristics of the multilayer ceramic capacitor 100 can be improved. It is possible to add copper and copper oxide to a metal conductive paste or the like for forming the internal electrode layers during manufacture.

Therefore, the internal electrode layer 12 may contain one or more types selected from copper and copper oxide. Copper and copper oxide may be contained in the internal electrode layer 12 by forming a compound with the base metal element contained in the internal electrode layer 12.

The proportions of copper and copper oxide contained in the internal electrode layer 12 are not particularly limited, and they can be added and contained to the extent that the intermediate region is formed. Details of the intermediate region 40 will be described later.

### (3-2) Thickness of Internal Electrode Layer

The thickness of the internal electrode layer 12 is not particularly limited, yet is preferably, for example, 0.8 μm or less, and more preferably 0.6 μm or less in order to be able to increase the capacitance by increasing the number of layers to be laminated while reducing the size of the multilayer ceramic capacitor 100.

The lower limit of the thickness of the internal electrode layer 12 is not particularly limited, yet may be 0.4 μm or greater in order to increase productivity and yield in a case of forming the internal electrode layer by, for example, printing a metal conductive paste by a printing method, such as screen printing, gravure printing, and the like. In the case of forming the internal electrode layer by a thin film process, such as sputtering, vapor deposition, and the like, the lower limit of the thickness can be 0.1 μm or greater, which is thinner than in the case of the printing method.

When evaluating the thickness of the internal electrode layer 12, the thickness is evaluated using a cross-section including the first axis that is equal to the lamination direction as in the evaluation of the thickness of the dielectric layer 11. For example, it is preferable to perform evaluation using either a cross-section further including the second axis set perpendicularly to the lamination direction, or a cross-section further including the third axis set perpendicularly to the lamination direction and also perpendicularly to the second axis, for ease with polishing and measurement

The multilayer ceramic capacitor 100 is polished such that the above-described cross-section becomes visible, and five layers are selected from each of a center part, an upper end part, and a lower end part of the exposed internal electrode layers 12 in the first axis direction. When the number of internal electrode layers 12 is even, six layers are selected from the center part. Then, the thickness of each selected internal electrode layer 12 is measured at a total of three positions, namely, a center part, a left end part, and a right end part, and the average value of the measured thicknesses is used as the thickness of each internal electrode layer 12. Furthermore, the average value of the thicknesses of all selected and evaluated internal electrode layers 12 can be used as the thickness of the internal electrode layers 12 in the multilayer ceramic capacitor 100.

The example shown in FIGS. 1 and 2, in which the first axis, which is along the lamination direction, is in the Z-axis direction, is an example in which the multilayer ceramic capacitor 100 is polished along the Y-axis to expose an XZ surface in which the dielectric layers 11 and the internal electrode layers 12 are laminated. In this case, five internal electrode layers 12 located at the center along the Z-axis, which is the first axis, and five internal electrode layers 12 located at each of the upper end and the lower end along the Z-axis, which is the first axis, are selected from the XZ surface exposed by polishing. When the number of internal electrode layers 12 is even, six layers may be selected from the center part. In this case, the internal electrode layers 12 to be selected are selected from within the capacitive part 14.

Then, the thickness of each selected internal electrode layer 12 is measured along the X-axis, which is the second axis, at three positions spaced apart from an end by ¼, ½, and ¾ the length of the internal electrode layer 12 along the X-axis, and is averaged as the thickness of the internal electrode layer 12. The thicknesses of all the selected internal electrode layers 12 are measured by the same procedure, and the average value of the thicknesses of all the selected and evaluated internal electrode layers 12 can be used as the thickness of the internal electrode layers 12 in the evaluated multilayer ceramic capacitor 100.

### (4) Intermediate Region

FIG. 4 shows an enlarged view of some of the dielectric layers 11 and the internal electrode layers 12 in the element body 10. FIG. 4 is an enlarged view of, for example, the region C of FIG. 3.

The multilayer ceramic capacitor 100 includes the intermediate regions 40 positioned between the dielectric layers 11 and the internal electrode layers 12. The intermediate regions 40 can contain copper and copper oxide.

Since FIG. 4 is a schematic view, the intermediate regions 40 are each shown as a continuous layer having a constant thickness. However, this configuration is non-limiting. For example, the intermediate regions 40 may be discontinuous, and varied in thickness from location to location.

The presence or absence of the intermediate region 40 can be confirmed using a Three-Dimensional Atom Probe (3DAP) analysis. Specifically, for example, a line analysis of a sample prepared to include the interface between the dielectric layer 11 and the internal electrode layer 12 can be performed using the three-dimensional atom probe analysis along the lamination direction of the dielectric layer 11 and the internal electrode layer 12. From the result of the line analysis, the region where the relative concentration of the base metal element contained in the internal electrode layer 12 is 90 at % or greater can be determined as the internal electrode layer 12. From the result of the line analysis, the region where the relative concentration of the base metal element contained in the internal electrode layer 12 is 5 at % or less can be determined as the dielectric layer 11. From the result of the line analysis, the region where the relative concentration of the base metal element contained in the internal electrode layer 12 is greater than 5 at % and less than 90 at % can be determined as a potential region to become the intermediate region 40.

When it is successfully confirmed that copper and copper oxide are distributed in the region between the dielectric layer 11 and the internal electrode layer 12 that can potentially become the intermediate region 40, the potential region to become the intermediate region 40 can be determined as the intermediate region 40. That is, it is possible to determine that the intermediate region 40 is present. When at least one of copper or copper oxide is not distributed in the region determined as the potential region to become the intermediate region 40, the region is not determined as the intermediate region 40, and it is possible to determine that an intermediate region 40 is absent.

The intermediate region 40 can contain copper and copper oxide. Copper means copper in the metal state, that is, in the form of a simple substance.

When the multilayer ceramic capacitor 100 is maintained in a DC bias-applied state for a long time, oxygen vacancies acting as donors migrate to the negative electrode side, and the dielectric material on the negative electrode side where oxygen vacancies are accumulated exhibits the n-type electrical conductivity. Then, oxygen vacancies disappear from the dielectric material on the positive electrode side located counter to the negative electrode. This activates acceptors that have been added to reduce leakage currents from the oxygen vacancies and have been neutralized by binding with the oxygen vacancies, to exhibit the p-type electrical conductivity.

The multilayer ceramic capacitor 100 of the present embodiment includes the intermediate regions 40 between the dielectric layers 11 and the internal electrode layers 12 as described above, and the intermediate regions 40 contains copper (Cu) and copper oxide (CuO). Copper (Cu) contained in the intermediate region 40 is considered to act as a barrier against n-type electrical conduction, and the copper oxide is considered to act as a barrier against p-type electrical conduction. Therefore, it is possible to reduce an increase in the leakage currents even after a voltage has been applied to the multilayer ceramic capacitor 100 of the present embodiment for a long time, and to prevent failures of the multilayer ceramic capacitor 100. As a result, the multilayer ceramic capacitor of the present embodiment can be a multilayer ceramic electronic component having excellent lifetime characteristics.

Since the multilayer ceramic capacitor 100 is typically used as a non-polar capacitor, separating it into a positive electrode and a negative electrode and adding copper and copper oxide to each of them increases the burden on the user when mounting the multilayer ceramic capacitor on electronic equipment.

In the multilayer ceramic capacitor of the present embodiment, there is no positive electrode-negative electrode delimitation, but the intermediate regions 40 are positioned between the dielectric layers 11 and the internal electrode layers 12, and the intermediate regions 40 contain copper and copper oxide. Therefore, it is possible to use the multilayer ceramic capacitor 100 without polarity identification when mounting, and to prevent an increase in the burden on the user.

According to the study of the inventor of the present invention, it is considered that a cause of deterioration occurs locally and simultaneously at a plurality of locations in the multilayer ceramic capacitor 100, which promotes deterioration.

On the other hand, in the multilayer ceramic capacitor 100 of the present embodiment, copper and copper oxide, which serves as barriers against electrical conduction, are distributed in the intermediate regions 40. Therefore, barriers exist at positions corresponding to local deteriorations, making it possible to prevent the expansion of the deterioration, and to consequently prolong the lifetime of the multilayer ceramic capacitor and enhance the lifetime characteristics thereof.

### (4-1) Copper and Copper Oxide

### (Distribution)

The distribution conditions of copper and copper oxide in the intermediate regions 40 are not particularly limited. For example, copper and copper oxide may be mixed and distributed throughout the entirety of the intermediate regions 40, or regions containing copper and regions containing copper oxide may exist independently without mixing in at least part of the intermediate regions 40.

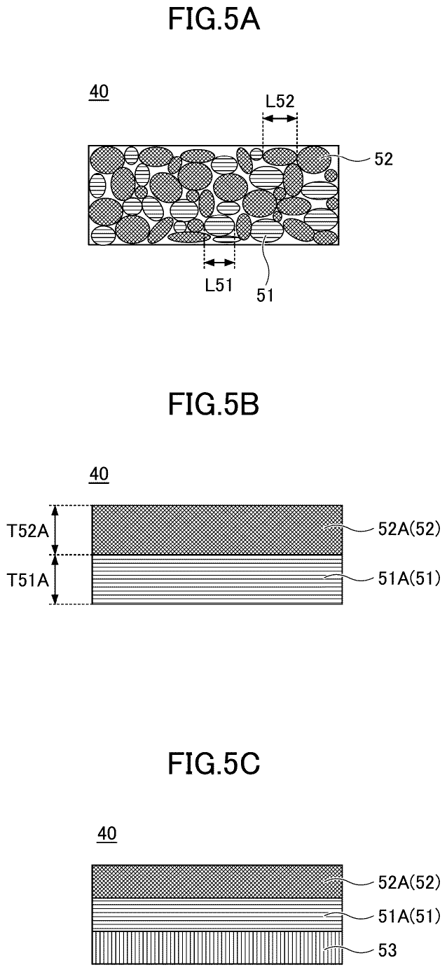

FIG. 5A shows an enlarged schematic view of the region D, which is a part of the intermediate region 40 in FIG. 4. As shown in FIG. 5A, regions 51 containing copper and regions 52 containing copper oxide may exist independently in the intermediate region 40. In this case, the regions 51 containing copper and the regions 52 containing copper oxide, which exist independently, can be described as being distributed in island forms. In FIG. 5A, the regions 51 containing copper and the regions 52 containing copper oxide are shown as circles or ellipses. However, this is a non-limiting feature, and the shape may be any shape. In FIG. 5A, although only one selected region is assigned the reference numeral due to space limitations, the figures with the same hatching mean the regions 51 containing copper or the regions 52 containing copper oxide.

With the regions 51 containing copper and the regions 52 containing copper oxide existing independently in the intermediate region 40, the regions 51 containing copper and the regions 52 containing copper oxide are considered able to function as the barriers against the n-type electrical conduction and p-type electrical conduction, respectively. Therefore, it is considered possible to particularly enhance the lifetime characteristics of the multilayer ceramic capacitor of the present embodiment.

Although the size of each region is not particularly limited, for example, the average value of the longer diameters L51 of the regions 51 containing copper and the average value of the longer diameters L52 of the regions 52 containing copper oxide may both be 1 nm or greater and 20 nm or less.

By adjusting the average value of the longer diameters L51 of the regions 51 containing copper and the average value of the longer diameters L52 of the regions 52 containing copper oxide to be 1 nm or greater, it is possible to make the barriers function as particularly high barriers against electrical conduction.

By adjusting the average value of the longer diameters L51 of the regions 51 containing copper and the average value of the longer diameters L52 of the regions 52 containing copper oxide to be 20 nm or less, it is possible to fill the intermediate region 40 with the regions 51 containing copper and the regions 52 containing copper oxide at a high density. Therefore, the intermediate region 40 can function as barriers having a particularly high performance against electrical conduction.

The method for measuring the average value of the longer diameters L51 of the regions 51 containing copper and the average value of the longer diameters L52 of the regions 52 containing copper oxide is not particularly limited. For example, it is possible to evaluate the longer diameters of two or more of each of the regions 51 containing copper and the regions 52 containing copper oxide that are contained in a region having a size of at least 30 μm×30 μm×50 μm and subjected to a three-dimensional atom probe analysis. Then, for example, the average value of the longer diameters L51 of the two or more regions, measured for the regions 51 containing copper, can be used as the average value of the longer diameters L51 of the regions 51 containing copper. The average value of the longer diameters L52 of the two or more regions, measured for the regions 52 containing copper oxide, can be used as the average value of the longer diameters L52 of the regions 52 containing copper oxide. The upper limit of the number of regions to be measured when calculating the average value of the longer diameters of the regions of each type is not particularly limited, yet can be, for example, 50 or less for each. The average value of the longer diameters L51 of the regions 51 containing copper and the average value of the longer diameters L52 of the regions 52 containing copper oxide may be the same or different.

The regions 51 containing copper and the regions 52 containing copper oxide may each be composed of a particle, or may be composed of, for example, an aggregate of a plurality of particles.

Further, the regions 51 containing copper and the regions 52 containing copper oxide may have a layered shape.

That is, as shown in FIG. 5B, a structure in which a copper-containing layer 51A serving as the region 51 containing copper and a copper oxide-containing layer 52A serving as the region 52 containing copper oxide are laminated may be used. FIG. 5B shows an example in which the intermediate region 40 includes one layer for each of the copper-containing layer 51A and the copper oxide-containing layer 52A. However, this is a non-limiting feature. The intermediate region 40 may include a plurality of copper-containing layers 51A and a plurality of copper oxide-containing layers 52A, respectively.

With the shape of the region 51 containing copper and the region 52 containing copper oxide being a layer shape, the intermediate region 40 can function as uniform barriers against electrical conduction between the dielectric layer 11 and the internal electrode layer 12. Therefore, it is considered that the lifetime characteristics of the multilayer ceramic capacitor 100 of the present embodiment are particularly enhanced by the shape of the region 51 containing copper and the region 52 containing copper oxide being a layer shape.

The thickness T51A of the copper-containing layer 51A and the thickness T52A of the copper oxide-containing layer 52A are not particularly limited. For example, the thickness T51A of the copper-containing layer 51A may be 1 nm or greater and 10 nm or less. The thickness T52A of the copper oxide-containing layer 52A may be 1 nm or greater and 10 nm or less.

By setting the thickness T51A of the copper-containing layer 51A and the thickness T52A of the copper oxide-containing layer 52A to be 1 nm or greater, it is possible to make the layers function as particularly high barriers against electrical conduction.

By setting the thickness T51A of the copper-containing layer 51A and the thickness T52A of the copper oxide-containing layer 52A to be 10 nm or less, it is possible to make the intermediate region 40 function as particularly high barriers against electrical conduction.

The method for measuring the thickness T51A of the copper-containing layer 51A and the thickness T52A of the copper oxide-containing layer 52A is not particularly limited.

The thickness T51A of the copper-containing layer 51A and the thickness T52A of the copper oxide-containing layer 52A can be measured by, for example, using a three-dimensional atom probe analysis. Specifically, a line analysis of a sample prepared to include the interface between the dielectric layer 11 and the internal electrode layer 12 can be performed along the lamination direction of the dielectric layer 11 and the internal electrode layer 12 by using a three-dimensional atom probe analysis.

From the result of the line analysis, the thickness, in the lamination direction, of a region in which copper is distributed within the region identified as the intermediate region 40 is measured at two or more non-overlapping positions, and the average value of the measured thicknesses can be used as the thickness T51A of the copper-containing layer 51A.

From the result of the line analysis, the thickness, in the lamination direction, of a region in which copper oxide is distributed within the region identified as the intermediate region 40 is measured at two or more non-overlapping positions, and the average value of the measured thicknesses can be used as the thickness T52A of the copper oxide-containing layer 52A.

The method for identifying the intermediate region 40 can be performed by the same procedure as the method for determining the presence or absence of the intermediate region 40. Since this method has already been described, description thereof is omitted. The lamination direction means the lamination direction of the dielectric layer 11 and the internal electrode layer 12.

Whether the region 51 containing copper and the region 52 containing copper oxide have a layer shape can be determined by, for example, performing a line analysis using the above-described three-dimensional atom probe analysis at a plurality of, for example, three or more, close, non-overlapping positions.

Although the positioning of the copper-containing layer 51A and the copper oxide-containing layer 52A is not particularly limited, for example, the coper-containing layer 51A and the copper oxide-containing layer 52A may be arranged in this order at positions closer to the internal electrode layer 12. The distribution of the copper-containing layer 51A and the copper oxide-containing layer 52A may be identified by, for example, a three-dimensional atom probe analysis. However, this is non-limiting. For example, identification may be performed by element mapping based on an energy dispersive X-ray (EDX) analysis using a transmission electron microscope (TEM) or a scanning transmission electron microscope (SEM).

TEM stands for a Transmission Electron Microscope and SEM stands for a Scanning Electron Microscope. EDX stands for Energy Dispersive X-ray spectroscopy.

The TEM/SEM-EDX evaluation can be performed using a cross-section including the first axis that is equal to the lamination direction. For example, it is preferable to perform evaluation using either a cross-section further including the second axis that is set perpendicularly to the lamination direction or a cross-section further including the third axis that is set perpendicularly to the lamination direction and also perpendicularly to the second axis, for ease with polishing and measurement. The example shown in FIGS. 1 and 2, in which the first axis that is the lamination direction is in the Z-axis direction, is an example in which the multilayer ceramic capacitor 100 is polished along the Y-axis that is the third axis, to expose an XZ surface in which the dielectric layers 11 and the internal electrode layers 12 are laminated. Then, by performing a TEM/STEM-EDX analysis of a sample obtained by forming the sample into a thin piece having a thickness of approximately 0.1 μm, it is possible to confirm the distribution of the copper-containing layer 51A and the copper oxide-containing layer 52A in the intermediate region 40. The distribution in a below-described layer containing a base metal-copper alloy may also be identified by the same method.

### (Concentration)

The concentration ratio between copper and copper oxide contained in the intermediate region 40 is not particularly limited.

For example, the ratio of the concentration of copper to the concentration of copper oxide in the intermediate region 40 may be 100% or greater and 200% or less.

By adjusting the ratio of the concentration of copper to the concentration of copper oxide in the intermediate region 40 to be 100% or greater and 200% or less, it is possible to make the intermediate region 40 function as well-balanced barriers against n-type and p-type electrical conduction, and to thereby particularly enhance the lifetime characteristics of the multilayer ceramic capacitor 100.

The method for measuring the ratio of the concentration of copper to the concentration of copper oxide in the intermediate region 40 is not particularly limited. It is possible to evaluate the concentrations of copper and copper oxide contained in, for example, a region having a size of at least 30 μm×30 μm×10 μm and subjected to a three-dimensional atom probe analysis within the intermediate region 40. Both the concentration of copper and the concentration of copper oxide can be calculated in at %. Then, the ratio of the determined concentration of copper to the determined concentration of copper oxide can be calculated. The ratio of the concentration of copper to the concentration of copper oxide can be calculated by the following equation, where the concentration of copper oxide is CuO and the concentration of copper is Cu.

(Ratio of concentration of copper to concentration of copper oxide)=Cu/CuO×100

### (4-2) Base Metal-Copper Alloy

The intermediate region 40 may contain components other than copper and copper oxide. For example, copper or copper oxide may react with the base metal contained in the internal electrode layer 12 to form a base metal-copper alloy. Therefore, the intermediate region 40 may contain the base metal-copper alloy.

As described above, nickel may be used as the base metal. Therefore, the intermediate region 40 may contain, for example, a nickel-copper alloy (Ni—Cu alloy) as the base metal-copper alloy.

When the intermediate region 40 contains the base metal-copper alloy, intrusion of hydrogen into the dielectric layer 11 can be reduced, and the moisture resistance of the multilayer ceramic capacitor can be improved.

For example, in FIG. 5A, a region containing the base metal-copper alloy may further be included in the intermediate region 40 as a different region independently from the regions 51 containing copper and the regions 52 containing copper oxide. The region containing the base metal-copper alloy may be mixed and distributed in one or more regions selected from the regions 51 containing copper and the regions 52 containing copper oxide.

For example, as shown in FIG. 5C, the intermediate region 40 may have a structure in which a base metal-copper alloy-containing layer 53, a copper-containing layer 51A, and a copper oxide-containing layer 52A are laminated.

The positioning of each layer is not particularly limited. For example, the base metal-copper alloy-containing layer 53, the copper-containing layer 51A, and the copper oxide-containing layer 52A may be arranged in this order at positions closer to the internal electrode layer 12.

### [Method for Manufacturing Multilayer Ceramic Capacitor]

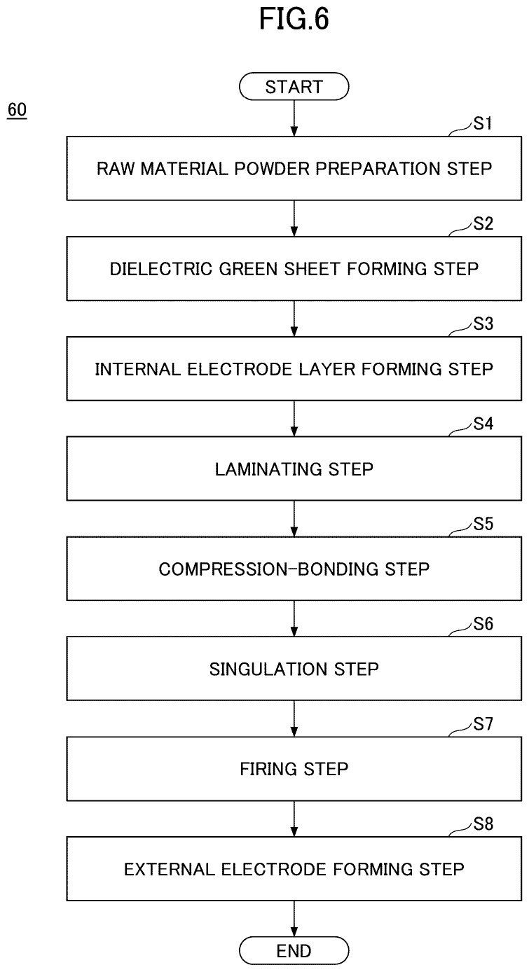

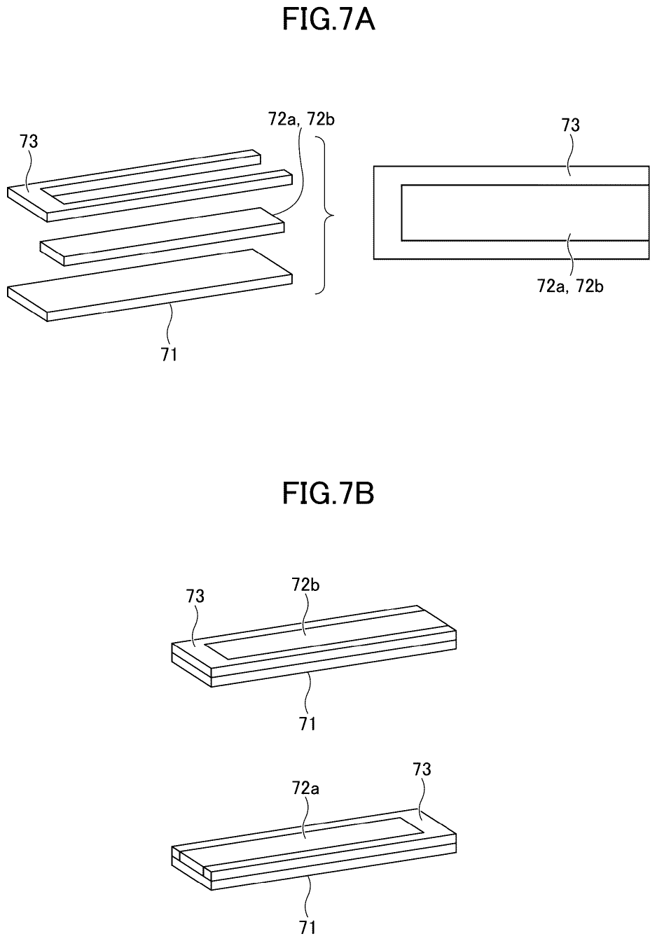

Next, a method for manufacturing the multilayer ceramic capacitor 100 will be described. FIG. 6 is a flowchart 60 showing the method for manufacturing the multilayer ceramic capacitor 100. FIG. 7 is a diagram showing the method for manufacturing the multilayer ceramic capacitor 100.

### (1) Raw Material Powder Preparation Step (S1)

In the raw material powder preparation step, first, a dielectric material for forming the dielectric layer 11 is prepared. The A-site element and B-site element contained in the dielectric layer 11 are usually contained in the dielectric layer 11 in the form of sintered bodies of particles of ABO_{3-α} (0≤α≤1). For example, barium titanate is a tetragonal crystal compound having a perovskite structure and exhibits a high relative permittivity. Barium titanate can generally be obtained by reacting a titanium material, such as titanium dioxide and the like, with a barium material, such as barium carbonate and the like. Various methods have been known for synthesizing the main component ceramic of the dielectric layer 11, such as solid-phase methods, sol-gel methods, hydrothermal methods, and the like. In the present embodiment, any of these methods can be employed.

In the raw material powder preparation step, predetermined additive compounds can be added to the obtained ceramic raw material powder according to the purpose. Examples of the additive compound include: an oxide containing one or more elements selected from zirconium (Zr), magnesium (Mg), molybdenum (Mo), vanadium (V), chromium (Cr), and rare earth elements (Scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)); an oxide containing one or more elements selected from cobalt (Co), nickel (Ni), lithium (Li), boron (B), sodium (Na), potassium (K), and silicon (Si); glass containing one or more elements selected from cobalt, nickel, lithium, boron, sodium, potassium, and silicon; and the like.

For example, a ceramic material can be prepared by wet-mixing a manganese-containing additive or an additive compound-containing compound with the ceramic raw material powder, and drying and pulverizing the resulting product. For example, as needed, the ceramic material obtained in the way described above may be subjected to a pulverizing treatment to adjust the particle diameter, or further to a classification treatment in combination to adjust the particle diameter. The dielectric material is obtained through these steps.

### (2) Dielectric Green Sheet Forming Step (S2)

In the dielectric green sheet forming step, a binder, such as polyvinyl butyral (PVB) resin and the like, an organic solvent, such as ethanol, toluene, and the like, and a plasticizer can be added to the raw material powder obtained in the raw material powder preparation step, and can be wet-mixed. The binder and the like may be added simultaneously when mixing the ceramic raw material powder in the raw material powder preparation step (S1), and may be wet-mixed.

In the dielectric green sheet forming step, a dielectric green sheet can be formed by applying the obtained slurry on a substrate by, for example, a die coater method or a doctor blade method, and drying them. The substrate is, for example, a polyethylene terephthalate (PET) film. A drawing showing the dielectric green sheet forming step is omitted.

Therefore, in the dielectric green sheet forming step (S2), a dielectric green sheet containing a dielectric material having the perovskite structure represented by the general formula: ABO_{3-α} (0≤α≤1) can be formed.

### (3) Internal Electrode Layer Forming Step (S3)

The first internal electrode layer 12a and the second internal electrode layer 12b can be mainly composed of one or more types selected from base metals, such as nickel (Ni), tin (Sn), tungsten (W), and the like, and alloys containing them. The internal electrode layers 12 may contain copper and copper oxide in addition to the above main component.

The main component of the first internal electrode layer 12a and the main component of the second internal electrode layer 12b may be the same or different. As an example, the main components of the first internal electrode layer 12a and the second internal electrode layer 12b may be the same and may both be nickel.

A metal conductive paste for forming a precursor of the first internal electrode layer 12a and the second internal electrode layer 12b may be prepared by kneading the selected main component, copper, copper oxide, an organic binder, and a solvent. Copper may be added in the state of a simple substance. Copper oxide may be added in the state of copper oxide.

In the internal electrode layer forming step, as shown in FIG. 7A, the metal conductive paste for internal electrode layer formation, containing an organic binder, can be printed on the surface of the dielectric green sheet 71 by screen printing, gravure printing, and the like. As the organic binder, for example, ethyl cellulose (EC), polyvinyl butyral (PVB) resin, and the like can be used. Thus, a first internal electrode layer pattern 72a for the first internal electrode layer 12a or a second internal electrode layer pattern 72b for the second internal electrode layer 12b is placed on the surface of the dielectric green sheet 71. Various auxiliary agents, such as a dispersant and the like, or ceramic particles serving as a co-existent material can also be added to the metal conductive paste. Although the main component of the ceramic particles is not particularly limited, the main component is preferably the same as the main component ceramic of the dielectric layer 11. When adding ceramic particles as a co-existent material, it is possible to add the during kneading of the metal conductive paste. The method for forming the internal electrode layer is not limited to printing, and plating, vacuum deposition, sputtering, or CVD may be used.

Further, it is possible to obtain a dielectric pattern paste for a reverse pattern layer by adding a binder, such as ethylcellulose-based binder and the like, and an organic solvent, such as terpineol-based organic solvent and the like, to the dielectric pattern material obtained in the raw material powder preparation step, and kneading them using a roll mill. Then, as shown in FIG. 7A, a dielectric pattern 73 may be placed on the dielectric green sheet 71 by printing the dielectric pattern paste on a peripheral region where no internal electrode layer pattern is printed, to fill the gap from the internal electrode layer pattern. The dielectric green sheet 71 on which the internal electrode layer pattern and the dielectric pattern 73 are printed is referred to as a lamination unit.

### (4) Laminating Step (S4)

In the laminating step, as shown in FIG. 7B, the lamination unit can be laminated such that the internal electrode layers and the dielectric layers are alternate and such that the edges of the internal electrode layers are exposed to the end surfaces of the dielectric layers on alternate sides in the length direction and extracted to alternate ones of a pair of external electrodes. Specifically, a dielectric green sheet 71 on which the first internal electrode layer pattern 72a and the dielectric pattern 73 are printed and a dielectric green sheet 71 on which a second internal electrode layer pattern 72b and the dielectric pattern 73 are printed are laminated in this order. For example, the number of lamination units to be laminated can be 100 layers to 500 layers.

### (5) Compression-Bonding Step (S5)

In the compression-bonding step, the laminate in which the lamination units are laminated can be thermally compression-bonded, with a predetermined number of, for example, two to ten, layers of cover sheets laminated on top and bottom of the laminate.

### (6) Singulation Step (S6)

In the singulation step, the compression-bonded body obtained by compression-bonding can be singulated into individual pieces, to obtain singulated laminates. Existing methods, such as dicing by a dicer, laser cutting, and the like can be used as appropriate as the singulation method.

### (7) Firing Step (S7)

In the firing step, the singulated laminates can be degreased and fired. In the firing step, degreasing treatment and firing treatment may be performed continuously or separately. Degreasing and firing conditions are not particularly limited. For example, degreasing may be performed in a nitrogen atmosphere at 250° C. or higher and 500° C. or lower.

For firing, firing may be performed for five minutes or longer and ten hours or shorter in a weakly oxidizing atmosphere in which the oxygen partial pressure is 10⁻¹² atm or higher and 10⁻⁸ atm or lower in a temperature range of 1,100° C. or higher and 1,350° C. or lower, or in a reducing atmosphere. The oxygen partial pressure may preferably be 10⁻¹² atm or higher and 10⁻¹⁰ atm or lower.

When using a reducing atmosphere, one or more types selected from hydrogen and carbon monoxide can be used as the reducing gas. The reducing gas may be used as a mixed gas with an inert gas, such as, for example, nitrogen, or a noble gas. Examples of the noble gas include helium and argon. By using a weakly oxidizing atmosphere or a reducing atmosphere, especially a strong reducing atmosphere during firing, it is possible to form the intermediate region containing copper and copper oxide.

The temperature range during firing may preferably be 1,150° C. or higher and 1,350° C. or lower. The firing time may preferably be 5 minutes or longer and shorter than 15 minutes.

When manufacturing a multilayer ceramic capacitor, there is a case where after firing, re-oxidation treatment is further performed at 600° C. or higher and 1,000° C. or lower in a nitrogen atmosphere. However, in the method for manufacturing the multilayer ceramic capacitor of the present embodiment, it is preferable to omit, i.e., to not perform, re-oxidation treatment.

### (8) External Electrode Forming Step (S8)

In the external electrode forming step, an external electrode can be formed by forming a metal conductive paste for external electrode layer formation, containing a main component base metal, such as nickel and the like, metals, such as copper and the like, and an organic binder, by screen printing, dipping, and the like, and then baking the paste. The method for forming an external electrode is not limited to printing or dipping, and plating, vacuum deposition, sputtering, or CVD may be used. Alternatively, an external electrode may be formed by forming a conductive resin paste by screen printing, dipping, and the like, and curing the resin. If necessary, a layer of copper, nickel, or tin may be formed by plating and the like. Thus, the first external electrode 20a and the second external electrode 20b can be formed. The multilayer ceramic capacitor 100 can be manufactured through the above steps.

The above steps are an example, and the method for manufacturing the multilayer ceramic capacitor of the present embodiment is not limited to the above embodiment. For example, an underlayer for an external electrode may be provided on a surface of a singulated laminate, and baked simultaneously with firing of the ceramic, to form an underlayer. In this case, in the external electrode forming step after firing, the external electrode is completed by forming a layer of copper, nickel, or tin on the underlayer by plating.

### Other Embodiments

Although the above-described embodiment has been described in detail, the present disclosure is not limited to the specific embodiment, and various modifications and changes are applicable within the scope of description in the claims.

For example, the above-described embodiment is applied to a multilayer ceramic capacitor having two terminal electrodes. However, it may also be applied to a multilayer ceramic capacitor having three or more terminals.

### EXAMPLES

Specific Examples will be described below. However, the present invention is not limited to these Examples.

Specific Examples will be described below. However, the present invention is not limited to these Examples.

### (1) Evaluation Method

### (1-1) Three-Dimensional Atom Probe Analysis

To perform a three-dimensional atom probe analysis, a needle-shaped sample having a tip diameter of 50 nm or greater and 100 nm or less, including an approximate interface between a dielectric layer 11 and an internal electrode layer 12, was manufactured by FIB, using the multilayer ceramic capacitor manufactured in each Example and Comparative Example. Then, a high electric field was applied and laser pulses were applied to the tip of the needle-shaped sample, to ionize the sample surface and analyze the atom distribution using a secondary detector. In this way, the three-dimensional atom probe analysis was performed.

A LEAP5000XS (obtained from AMETEK Inc.) was used as the three-dimensional atom probe analyzer. The wavelength of the laser pulses applied to the needle-shaped sample was 355 nm.

The presence or absence of the intermediate region 40 was determined by the following procedure.

A line analysis of the needle-shaped sample was performed along the lamination direction of the dielectric layer 11 and the internal electrode layer 12, using a three-dimensional atomic probe analysis. From the result of the line analysis, a region in which the relative concentration of the base metal element contained in the internal electrode layer 12 was 90 at % or greater was determined as the internal electrode layer 12. A region in which the relative concentration of the base metal element contained in the internal electrode layer 12 was 5 at % or less was determined as the dielectric layer 11. A region in which the relative concentration of the base metal element contained in the internal electrode layer 12 was greater than 5 at % and less than 90 at % was determined a potential region that could be an intermediate region 40.

When it was successfully confirmed from the result of the line analysis that copper and copper oxide were distributed in the potential region that could be the intermediate region 40 between the dielectric layer 11 and the internal electrode layer 12, the potential region that could be the intermediate region 40 was determined as the intermediate region 40. When at least one of copper or copper oxide was not distributed in the potential region that could be the intermediate region 40, the region was not determined as the intermediate region 40, and it was determined that no intermediate region 40 was present.

The relative concentration of each element was calculated such that the sum of Ba, Ti, O, Cu, and Ni, which were elements detected by the three dimensional atom probe analysis, would be 100 at %.

### (1-2) Accelerated Life Test

Fifty samples were prepared for each of the multilayer ceramic capacitors manufactured in each Example and Comparative Example. An accelerated life test (HALT: Highly Accelerated Life Test) was performed for each selected sample. In the accelerated life test, a voltage of 10 V was applied to each of the fifty samples manufactured under the same condition in a thermostat bath at 125° C., and the time taken until insulation deterioration occurred was measured.

During the evaluation, the insulation resistance was measured, and when the insulation resistance value became less than 1 MΩ, it was determined that insulation deterioration occurred.

The average value of the time taken until insulation deterioration occurred, regarding the fifty samples evaluated was evaluated as the time taken until insulation deterioration occurred, i.e., the lifetime, of the samples of each Example and Comparative Example.

The evaluation result is shown in the “Lifetime” field of Table 1. The larger the value, the better the lifetime characteristics.

When the lifetime was 500 minutes or longer, the lifetime was evaluated as A. When the lifetime was shorter than 500 minutes, the lifetime was evaluated as C.

When the lifetime evaluation was A, the multilayer ceramic capacitor can be evaluated as having excellent lifetime characteristics.

### (2) Sample Preparation Conditions

### Example 1

### (2-1) Raw Material Powder Preparation Step

A multilayer ceramic capacitor was manufactured according to the flowchart 60 shown in FIG. 6.

Specifically, a barium titanate powder, a polyvinyl butyral (PVB) resin, a solvent, a plasticizer, and a glass powder containing SiO₂ as a sintering aid were wet-mixed to obtain a slurry.

### (2-2) Dielectric Green Sheet Forming Step

The obtained slurry was applied to a substrate film, and the slurry applied to the substrate film was dried to obtain a dielectric green sheet.

### (2-3) Internal Electrode Layer Forming Step

Next, a copper powder and a copper oxide powder were added and mixed with an Ni powder serving as a main component metal element, to prepare a mixed powder. Ethyl cellulose (EC), polyvinyl butyral (PVB) resin, or the like serving as a binder, a solvent, and a plasticizer were added and wet-mixed with the prepared mixed powder, to obtain a metal conductive paste for internal electrode layer formation. Then, the metal conductive paste was printed on a partial region of the surface of the dielectric green sheet, to form an internal electrode layer pattern containing nickel, which was the main component base metal element, copper, and copper oxide on each dielectric green sheet.

A lamination unit was produced through the dielectric green sheet forming step and the internal electrode layer forming step described above. The lamination unit thus obtained had the dielectric green sheet and the internal electrode layer pattern formed on the surface of the dielectric green sheet.

### (2-4) Laminating Step

Next, five-hundred lamination units were laminated to form a laminate.

### (2-5) Compression-Bonding Step and Singulation Step

Then, the laminate was subjected to compression-bonding and then singulated, to obtain a chip-shaped green laminate.

### (2-6) Firing Step

Next, the chip-shaped green laminate was degreased in a nitrogen atmosphere at 500° C.

As an underlayer, a metal conductive paste containing a metal filler mainly composed of nickel, a co-existent material, a binder, a solvent, and the like was applied to the green laminate after being degreased, from both end surfaces to each side surface thereof, and dried. Subsequently, the green laminate to which the underlayer for external electrodes was applied was put into a firing furnace and fired.

In the firing step, the green laminate was kept at a firing temperature of 1,300° C. for 10 seconds under a reducing atmosphere, which was a mixed atmosphere of hydrogen and nitrogen, and in which the oxygen partial pressure was 1.0×10⁻¹⁰ atm. When raising the temperature, the amount of green laminates to be fed and the oxygen partial pressure were adjusted so as to not cause a sudden change in the firing atmosphere due to gas that might be generated from the green laminates and to prevent cracking of the fired products.

### (2-7) External Electrode Forming Step

The first external electrode 20a and the second external electrode 20b were formed on the laminate after being fired, by plating.

The resulting multilayer ceramic capacitor had a chip shape of 1.0 mm×0.5 mm×0.5 mm, the thickness of the dielectric layers 11 was 0.8 μm, the thickness of the internal electrode layers 12 was 0.6 μm, and the number of layers laminated was 500. The thicknesses of the dielectric layers 11 and the internal electrode layers 12 were evaluated by the procedure described above.

The obtained multilayer ceramic capacitor was evaluated in terms of the items described above. The evaluation results are shown in Table 1.

### Comparative Example 1

A multilayer ceramic capacitor was manufactured by the same procedure as in Example 1, except that no copper powder and copper oxide powder were added and mixed with an Ni powder, which was the main component metal element, in the internal electrode layer forming step, and was evaluated. The evaluation results are shown in Table 1.

### Comparative Example 2

In the internal electrode layer forming step, a copper powder was added and mixed with an Ni powder, which was the main component metal element, but no copper oxide powder was added and mixed. Except for the above points, a multilayer ceramic capacitor was manufactured by the same procedure as in Example 1, and was evaluated. The evaluation results are shown in Table 1.

### Comparative Example 3

In the internal electrode layer forming step, a copper oxide powder was added and mixed with an Ni powder, which was the main component metal element, but no copper powder was added and mixed. Except for the above points, a multilayer ceramic capacitor was manufactured by the same procedure as in Example 1, and was evaluated. The evaluation results are shown in Table 1.

TABLE 1

| | Presence or absence | |
|---|---|---|
| | of intermediate region | Lifetime |
| Ex. 1 | Present | A |
| Comp. Ex. 1 | Absent | C |
| Comp. Ex. 2 | Absent | B |
| Comp. Ex. 3 | Absent | B |

According to Table 1, it could be confirmed that Example 1 having intermediate regions 40 between the dielectric layers 11 and the internal electrode layers 12, with copper and copper oxide contained in the intermediate regions 40, achieved higher lifetime characteristics than those of Comparative Example 1 to Comparative Example 3 that include no intermediate regions 40.

In Comparative Example 2 and Comparative Example 3, although regions containing either copper or copper oxide could be confirmed between the dielectric layers 11 and the internal electrode layers 12, copper and copper oxide could not both be confirmed in the regions.

In Comparative Example 2 and Comparative Example 3, although regions containing either copper or copper oxide could be confirmed between the dielectric layers 11 and the internal electrode layers 12 as described above, it was confirmed that the lifetime characteristics were inferior to those of Example 1.

Aspects of the present disclosure are, for example, as follows.

<1>

A multilayer ceramic electronic component, comprising:
a plurality of dielectric layers laminated along a first axis;
a plurality of internal electrode layers, each of which is located between the dielectric layers that are adjacent along the first axis; and
intermediate regions located between the dielectric layers and the internal electrode layers,
wherein the dielectric layers contain a compound represented by a general formula of ABO_{3-α} (0≤α≤1) and having a perovskite structure,
the internal electrode layers contain a base metal element as a main component, and
the intermediate regions contain copper and copper oxide.
   <2>

The multilayer ceramic electronic component according to <1>,
wherein a region containing the copper and a region containing the copper oxide exist independently from each other in the intermediate regions.
   <3>

The multilayer ceramic electronic component according to <2>,
wherein an average value of longer diameters of regions containing the copper, each of the regions being the region containing the copper, and an average value of longer diameters of regions containing the copper oxide, each of the regions being the region containing the copper oxide, are both 1 nm or greater and 20 nm or less.
   <4>

The multilayer ceramic electronic component according to <2>,
wherein the region containing the copper and the region containing the copper oxide have a layer shape.
   <5>

The multilayer ceramic electronic component according to any one of <1> to <4>,
wherein a ratio of a concentration of the copper to a concentration of the copper oxide in the intermediate regions is 100% or greater and 200% or less.
   <6>

The multilayer ceramic electronic component according to any one of <1> to <5>,
wherein the internal electrode layers contain nickel as the base metal element.
   <7>

The multilayer ceramic electronic component according to any one of <1> to <6>,
wherein the dielectric layers contain barium titanate as the compound having the perovskite structure.

What is claimed is:

1. A multilayer ceramic electronic component, comprising:
a plurality of dielectric layers laminated along a first axis;
a plurality of internal electrode layers located between the dielectric layers that are adjacent along the first axis; and
intermediate regions located between the dielectric layers and the internal electrode layers,
wherein the dielectric layers contain a compound represented by a general formula of ABO_{3-α} (0≤α≤1) and having a perovskite structure,
the internal electrode layers contain a base metal element as a main component, and
the intermediate regions contain copper and copper oxide.

2. The multilayer ceramic electronic component according to claim 1,
wherein a region containing the copper and a region containing the copper oxide exist independently from each other in the intermediate regions.

3. The multilayer ceramic electronic component according to claim 2,
wherein an average value of longer diameters of regions containing the copper, each of the regions being the region containing the copper, and an average value of longer diameters of regions containing the copper oxide, each of the regions being the region containing the copper oxide, are 1 nm or greater and 20 nm or less.

4. The multilayer ceramic electronic component according to claim 2,
wherein the region containing the copper and the region containing the copper oxide have a layer shape.

5. The multilayer ceramic electronic component according to claim 1,
wherein a ratio of a concentration of the copper to a concentration of the copper oxide in the intermediate regions is 100% or greater and 200% or less.

6. The multilayer ceramic electronic component according to claim 1,
wherein the internal electrode layers contain nickel as the base metal element.

7. The multilayer ceramic electronic component according to claim 1,
wherein the dielectric layers contain barium titanate as the compound having the perovskite structure.
